(19) United States
(12) Patent Application Publication
(10) Pub. No.: US 2024/0158291 A1
(43) Pub. Date: May 16, 2024

(54) METHOD FOR PRODUCING A COLOR COATING

(71) Applicant: FERRO GMBH, Frankfurt am Main (DE)

(72) Inventors: Marya KHAN, Langen (DE); Dagmar KORBELARZ, Hanau (DE); Andreas SCHULZ, Karben (DE); Dietrich SPEER, Langenselbold (DE)

(21) Appl. No.: 18/282,085

(22) PCT Filed: May 24, 2022
(86) PCT No.: PCT/EP2022/063969

§ 371 Date: Sep. 14, 2023

(30) Foreign Application Priority Data
May 31, 2021 (DE) 102021114007.2

(51) Int. Cl. C03C 17/00; C09D 11/033; C09D 11/037

(52) U.S. Cl. CPC C03C 17/007; C09D 11/033; C09D 11/037; C03C 2217/452; C03C 2217/485; C03C 2217/78; C03C 2218/119; C03C 2218/32

(57) ABSTRACT

The present invention relates to a method for producing a colored coating on a glass surface by way of a printing method. According to the method, A) a printing substance is applied to a glass surface, the printing substance comprising at least one pigment precursor; and B) the pigment precursor applied to the glass surface is converted to pigment particles. The present invention also describes a printing substance for carrying out the method and a coated glass substrate.

### CROSS-REFERENCE TO RELATED APPLICATIONS

This application claims priority to PCT Patent Application No. PCT/EP2022/063969 filed 24 May 2022, and German Application No. 10 2021 114 007.2, filed 31 May 2021, which are hereby incorporated by reference in their entireties.

### FIELD OF THE INVENTION

The present invention relates to a method for producing a colored coating, a printing substance for carrying out the same, and a coated glass substrate.

### BACKGROUND OF THE INVENTION

The use of enamel compositions on glass substrates, in particular glass panes for automobile construction, is known. This is done, for example, to achieve decorative and protective effects (EP1289897 by St. Gobain and EP3365291 by Pilkington). For this purpose, black screen printing color pastes are used, which contain approx. 80-90% solids, which in turn consist of approx. 80% of a glass frit, usually containing bismuth, and approx. 20% of a black pigment (preferably pigments of the spinel system, such as CuCr₂O₄).

In EP1893541 and WO 2006/134356 by Pilkington, a method is claimed which is particularly suitable for use in roof glazing. These glasses have an optical transmission of 10-50%, which corresponds to an optical density of 1 to 0.3. (The optical density is the negative logarithm of the percentage transmission.) Inks are used here—also digitally printable—that are based on finely ground pigments and glass frits with particle sizes <1.2 μm with a pigment content of 5-15%. The compositions of such inks, which have a low viscosity of about 20 m Pas, are described in WO 2005/019360 by Ind. Techno. Logic. Solutions.

The enamel compositions set forth above serve, among other things, to form the opaque perimeter band found on the windshield, side windows, skylight and rear window of a motor vehicle. By absorbing UV radiation, it preserves the integrity of the adhesive under the glass pane after it has been installed in the bodywork opening by means of a bonding operation. Such enamel colors are also suitable for the decoration of skylights.

In general, the enamel compositions are formed from a powder comprising a glass frit, pigments, a solvent or suspending agent and other additives. The glass frit serves to form a glass matrix, wherein the pigments can be a component of the frit.

The pigments contained as colorants are, in particular, gray or black. The pigments are mostly metal oxides such as copper, chromium, cobalt, nickel and iron oxides, which do not react with the other components of the composition. The suspending agent and combination with suitable organic binders and viscosity-controlling additives ensure the necessary stable suspension of the solid particles and the adhesion of the ink or printing paste to the glass substrate. The suspension medium is generally based on organic solvents, such as are used in a wide variety of printing inks (alcohols, glycols, etc.). The actual decoration firing, in which the enamel composition—namely ultimately the color layer—is firmly molten with the glass substrate, preferably takes place at temperatures of 600 to 700° C., wherein the glass plate is exposed to the maximum temperature for approx. 3.6 minutes.

The known enamel compositions can be used in accordance with the methods set out above for printing on glass. However, it is often necessary to produce small pigments in order to obtain a low viscosity. This is very time-consuming. A major problem, however, is that the coatings obtained with the enamel compositions presented above cause a sharp reduction in bending strength. This means that the uncoated glass substrate has a much higher bending strength than the glass substrate coated with conventional enamel com positions.

### SUMMARY OF THE INVENTION

In view of the prior art, it is now the object of the present invention to provide a coated glass substrate with a coating which causes a slight decrease in the bending strength, based on the bending strength of the uncoated glass substrate.

In view of the prior art, it is another object of the present invention to provide a printing substance for coating glass surfaces, by which a coating is provided which causes a small decrease in bending strength relative to the bending strength of the uncoated glass substrate.

Furthermore, the coating should have high adhesion to the glass substrate. A further object is to provide a printing substance which results in a coating with high adhesion on a glass substrate.

In addition, the coating obtained from the printing substance should have the highest possible acid and scratch resistance. Furthermore, the printing substance should be able to be obtained as simply and inexpensively as possible. Furthermore, the printing method based on this concept should be able to be carried out with low costs and high efficiency. These and other problems not explicitly mentioned, which can be easily derived or deduced from the context discussed in the introduction, are achieved by a coated glass substrate with all the features of claim 1. Expedient modifications of the glass substrate according to the invention are protected in the dependent claims. With regard to the method for producing a coated glass substrate and the printing substance for carrying out the method, the subject matter of claims 10 to 23 provide a solution to the underlying problem.

### BRIEF DESCRIPTION OF THE DRAWINGS

FIG. 1 is a cross-section of an electron micrograph of an exemplary coating thickness.

FIG. 2 shows the formation of pigment particles in an exemplary coating.

FIG. 3 shows an electron micrograph of an exemplary coating thickness.

FIG. 4 shows the formation of pigment particles by electron microscopy.

FIG. 5 is a cross-section of an electron micrograph of an exemplary coating thickness.

FIG. 6 shows the formation of pigment particles in an exemplary coating.

FIG. 7 is a cross-section of an electron micrograph, showing coating thickness.

FIG. 8 shows the surface of the coating.

FIG. 9 shows an electron micrograph of an exemplary coating thickness.

FIG. 10 shows the formation of pigment particles by electron microscopy.

FIG. 11 is a cross-section of an electron micrograph of an exemplary coating thickness.

FIG. 12 shows the formation of pigment particles by electron microscopy.

FIG. 13 is a cross-section of an electron micrograph of an exemplary coating thickness.

FIG. 14 shows the formation of pigment particles by electron microscopy.

### DETAILED DESCRIPTION OF THE INVENTION

The subject matter of the present invention is a coated glass substrate, the coating comprising an inorganic glass matrix and pigment particles, characterized in that the coating has a thickness in the range from 0.6 μm to 8 μm in the burned-out state and the color values of the coating in the range for L*≤15, lie for a* between −5 and +6, for b* between −4 and +5.

As a result of these configurations, glass substrates with a colored coating exhibit a high bending strength. The colored coating has a high adhesion on the glass substrate. This coating essentially corresponds to coatings as are known from the prior art for corresponding purposes. The colored coating is based on a glass matrix that is inorganic in nature. The color is caused by pigment particles obtained in step B) of the process detailed later. Further details of the colored coating result from the following description of the printing substance to be preferably used.

Furthermore, it can be provided that the part of the glass substrate provided with a coating has an optical density of at least 1.0, preferably at least 2.0, particularly preferably at least 3.0. The optical density can be measured using conventional methods, including using a transmission densitometer, for example a Gretag D 200-11. Measurement method 1, as set out in the operating instructions, can preferably be used here.

Furthermore, it can be provided that the coating of the glass substrate comprises pigment particles, wherein the pigment particles have an average particle diameter in the range from 0.05 μm to 0.8 μm, preferably from 0.08 μm to 0.8 μm, particularly preferably from 0.1 to 0.5 μm wherein the average size is determined from the numerical mean of scanning electron micrographs using at least 20 pigment particles.

In addition, it can be provided that the coating of the glass substrate has a scratch resistance of at least 5 N, measured with a scratch hardener model 318 with rollers tip 1.0 from Erichsen.

Furthermore, it can be provided that the glass substrate is selected from a windscreen, a side window, a rear window and/or a roof window of a motor vehicle. The usual roof windows of a motor vehicle include, for example, panoramic roofs or panoramic sunroofs. Furthermore, it can be provided that the glass substrate is only coated on part of the glass surface.

Provision can also be made for at least one network former precursor and/or at least one network modifier precursor to form a glass matrix. The glass matrix acts as an adhesion promoter or adhesion enhancer between the substrate and the pigment.

It can advantageously be provided that the coating applied to the glass substrate does not completely cover the glass substrate, preferably the coating applied to the glass substrate covers the edge of the glass substrate, wherein the edge covered by the coating preferably has a width in the range from 0.5 cm to 20 cm, preferably in the range of 0.5 cm to 5 cm, and the glass substrate has an inner uncoated region surrounded by the edge.

In addition, it can be provided that the coating in the burned-out state has a thickness in the range from 0.8 to 4.0 μm and particularly preferably in the range from 1.0 to 3.0 μm. Furthermore, it can be provided that the color values of the coating applied to the glass substrate are in the range for 1_*5, for a* between −1 and +1 and for b* between −1.7 and +1.5. Further preferred color values of the coating applied to the glass substrate are set out later, and reference is made thereto.

Another object of the present invention is a method for producing a coated glass substrate according to the present invention with a printing process in which
A) a printing substance is applied to a glass surface, the printing substance comprising at least one pigment precursor; and
B) the pigment precursor applied to the glass surface is converted into pigment particles by a heating step.

With this configuration, colored coatings can be obtained on glass surfaces, which cause only a very small decrease in the bending strength in relation to the glass substrate. The colored coating has a high adhesion on the glass substrate.

In addition, the colored coating obtained from the printing substance has a very high acid and scratch resistance. In particular, the colored coating withstands the usual loads. Furthermore, the printing substance can be obtained simply and inexpensively, and the printing method based thereon can be carried out very easily using known systems. Furthermore, the printing process can be carried out with very high throughput rates. In step A) a printing substance is applied to a glass surface. In principle, this can be done using any customary printing method, wherein the viscosity values of the printing substance can be adapted to the method with which the printing substance is applied to the glass surface. However, it has turned out to be preferred that the printing substance in step A) is applied to the glass surface by ink jet printing or screen printing, preferably screen printing.

The printing substance applied to a glass surface in step A) comprises at least one pigment precursor. Particularly suitable pigment precursors are described in connection with printing substances which are to be used preferentially.

In step B), the pigment precursor applied to the glass surface is converted into pigment particles. This conversion of the pigment precursor into pigment particles can be accomplished by any suitable method, dictated by the nature of the pigment precursor. The pigment precursor applied to the glass surface in step B) can preferably be converted into pigment particles by a heating step.

The heating step which is preferably provided for converting the pigment precursor into pigment particles can comprise a number of sub-steps, namely in particular stages or ramps, in order to arrive at a suitable temperature. It can preferably be provided that the heating step involves firing the coated glass surface to a temperature in the range from 400° C. to 1000° C., preferably 550° C. to 750° C., particularly preferably 620° C. to 700° C., particularly preferably 650° C. to 690° C.

Furthermore, it can be provided that the heating step is carried out over a period of 1 minute to 180 minutes, preferably 1 to 20 minutes, particularly preferably 1 to 5 minutes. A temperature in the range from 400° C. to 1000° C., preferably 550° C. to 750° C., particularly preferably 620° C. to 700° C., especially preferably 650° C. to 690° C., is particularly preferred for the times mentioned of 1 minute to 180 minutes, preferably 1 to 20 minutes, more preferably 1 to 5 minutes.

The coating thickness with which the printing substance is applied to a glass surface in step A) (wet layer thickness) can be within a wide range. Provision can preferably be made for the printing substance in step A) to be applied to a glass surface in a thickness in the range from 0.5 μm to 40 μm, preferably from 1 to 20 μm. In a further preferred embodiment it can be provided that the coating thickness with which the printing substance is applied to a glass surface in step A) is in the range from 0.5 μm to 40 μm, preferably 10 to 30 μm.

The method of the present invention is particularly useful for forming an opaque perimeter band to be created on the windscreen, side windows, skylight and rear window of a motor vehicle in order to preserve the integrity of the adhesive under the glass pane by absorbing UV radiation after it has been installed in the body opening by means of a bonding process. The method is also suitable for decorating skylights. It can therefore be provided that the printing substance in step A) is only applied to part of the glass surface. Furthermore, it can be provided that the printing substance comprises at least one network former precursor and/or network modifier precursor and at least one pigment precursor, the pigment precursor being soluble in an organic solvent, and the pigment precursor comprising at least one transition metal. The printing substance particularly preferably comprises at least one network former precursor.

The type and amount of pigment precursor depends on the pigment particles to be obtained from the pigment precursor. Here, the pigment precursor can be used as a single compound or as a mixture of two, three or more pigment precursors. The pigment precursor preferably comprises at least one transition metal convertible into pigment particles.

Provision can preferably be made for the transition metal contained in the pigment precursor to be selected from cobalt, iron, nickel, manganese, chromium, copper, aluminum, titanium, molybdenum, preferably cobalt, iron, chromium, copper, manganese, particularly preferably cobalt or iron.

Furthermore, it can be provided that the transition metal contained in the pigment precursor is selected from iron, nickel, manganese, chromium, copper, aluminum, titanium, molybdenum, ruthenium, preferably iron, chromium, copper, manganese, particularly preferably iron and chromium or copper, chromium, iron or copper, manganese, iron or copper and manganese.

Provision can particularly preferably be made for the transition metal contained in the pigment precursor to consist of cobalt or a mixture of cobalt and iron or a mixture of manganese, iron and copper or a mixture of manganese and copper or a mixture of copper and cobalt.

In step B) of the method set out above and below, the pigment precursor is converted into pigment particles. The pigment particles obtained preferably correspond to the pigments known from the prior art which are used for the purposes mentioned and are preferably metal oxides such as copper, chromium, cobalt, nickel and iron oxides, mixed oxides also being known.

Pigment particles to be preferably obtained are preferably oxides, such as, for example, spinels, for example Co₃O₄, and also silicates, etc., such as those used in the prior art set out in the introductory part of the present application.

Preferably, the pigment precursor is an organic solvent-soluble complex and/or an organic solvent-soluble salt of a transition metal. Inter alia, amines such as diethyleneamine, bipyridyl, terpyridine, ethanolamine, diethanolamine or triethanolamine; alcoholates, hydroxides, sulfates, sulfonates, carbonates, carboxylates and/or other carbonyl compounds are used. Preferred sulfonates include salts and/or complexes of methanesulfonic acid. The preferred carboxylates, which particularly preferably correspond to the formula (CH₃CₙH₂ₙCOO— with n=0-18), include decanoate, neodecanoate, 2-ethylhexanoate, cyclohexanoate, acrylates, oleates, benzoates. Furthermore, dicarboxylic acids can be used to form the complexes and/or salts, which acids particularly preferably correspond to the formula (HOOCCₙH₂ₙCOOH with n=0-10), such as oxalic acid, malonic acid, or sebacic acid, maleic acid or fumaric acid. Furthermore, as a ligand and/or salt component, hydroxycarboxylates such as derivatives of glycolic acid, lactic acid, malic acid, mandelic acid, tartaric acid, citric acid, and/or ketocarboxylates such as salts/complexes of glyoxylic acid, pyruvic acid, acetoacetic acid or ethyl acetoacetate and/or amino carboxylates such as salts/complexes of amino acids such as glycine, alanine, valine, leucine, isoleucine, phenylalanine, tyrosine, proline, hydroxyproline, serine, threonine, cysteine, cystine, methionine, tryptophan, aspartic acid; Glutamic acid, arginine, lysine, histidine can be used.

It can be provided in this case that the pigment precursor is a complex which is soluble in an organic solvent, for example: with the ligands diethyleneamine, bipyridyl, terpyridine, ethanolamine, diethanolamine or triethanolamine and/or alcoholates, acetylacetonates, carboxylates (CH₃CₙH₂ₙCOO— with n=0-18), such as: decanoate, neodecanoate, 2-ethylhexanoate, cyclohexanoate; but also an unsaturated carboxylate such as salts/complexes of acrylic acid, oleic acid, benzoic acid, etc.; and/or a dicarboxylate such as salts/complexes of dicarboxylic acids (HOOCCₙH₂ₙCOOH with n=0-10) such as oxalic acid, malonic acid or sebacic acid or salts/complexes of unsaturated dicarboxylic acids such as maleic acid or fumaric acid and/or Hydroxycarboxylates, such as salts/complexes of glycolic acid, lactic acid, malic acid, mandelic acid, tartaric acid, citric acid; and/or ketocarboxylates, such as salts/complexes of glyoxylic acid, pyruvic acid, acetoacetic acid or ethyl acetoacetate; and/or amino carboxylates such as salts/complexes of amino acids such as glycine, alanine, valine, leucine, isoleucine, phenylalanine, tyrosine, proline, hydroxyproline, serine, threonine, cysteine, cystine, methionine, tryptophan, aspartic acid; glutamic acid, arginine, lysine, histidine, of a transition metal.

The sum amount of pigment precursors, one or more, is preferably 0.5 to 80% by weight, particularly preferably 10 to 70% by weight, especially preferably 25 to 60% by weight, based on the weight of the printing substance, depending on the type of pigment precursors and the desired opacity.

In a particularly preferred embodiment it can be provided that the sum amount of pigment precursors, one or more, is preferably 0.5 to 95% by weight, particularly preferably 10 to 85% by weight, especially preferably 25 to 60% by weight, based on the weight of the printing substance, depending on the type of pigment precursors and the desired opacity. In addition to one or more pigment precursors, it can be provided that the printing substance comprises at least one network former precursor and/or network modifier precursor, the printing substance preferably having at least one network former precursor, particularly preferably a mixture of network former precursor and network modifier precursor. Here, the network former precursor can be used as an individual component or as a mixture of two, three or more network-former precursors. Moreover, the network modifier precursor can be used as an individual component or as a mixture of two, three or more network modifier precursors.

The terms “network former” and “network modifier” are widely known in the professional world, wherein the terms “network former precursor” and “network modifier precursor” are based on them, and a precursor, also known as a precursor, is a compound that can be converted into a desired substance, so that a network former precursor can be converted by appropriate reactions into a network former. Other terms such as “pigment precursor” and “network modifier precursors” are similarly affected.

An inorganic network is preferably formed by the network-forming precursor contained in the printing substance, which network can particularly preferably be formed by SiO₄-tetrahedrons. The cations that build up such network-forming polyhedra are therefore referred to as network formers, while the cations that break down or change the network are called network modifiers. Network formers include, inter alia, Si, Ge, B, Bi, Sb, As and P, network modifiers including alkalis and alkaline earths. Al₂O₃, TiO₂, SnO₂, ZrO₂, MgO can partially replace the SiO₂ in the glass structure, in this case they act as network formers. If they don't, they act as network modifiers.

It can preferably be provided that the network former precursor comprises at least one silicon compound, a boron compound and/or a bismuth compound.

Furthermore, it can be provided that the network former precursor comprises at least one silicon compound, preferably an alkoxysilane. Preferred alkoxysilanes include tetraethoxysilane, tetramethoxysilane, tetrabutoxysilane, methyltrimethoxysilane, methyltriethoxysilane, methyltriisopropoxysilane, methyltributoxysilane, methyltriisopropenoxysilane, dimethyldimethoxysilane, dimethyldiethoxysilane, dimethyldiisopropoxysilane, dimethyldibutoxysilane, dimethyldiisopropenoxysilane, trimethylmethoxysilane, trimethylethoxysilane, trimethylisopropenoxysilane, ethyltrimethoxysilane, butyltrimethoxysilane, hexyltrimethoxysilane, dodecyltrimethoxysilane, decyltrimethoxysilane, dodecyltriethoxysilane, decyltriethoxysilane, phenyltriethoxysilane, phenyltrimethoxysilane, cyclohexyltriethoxysilane, cyclohexyltrimethoxysilane, propylmethyldiethoxysilane, propylmethyldimethoxysilane, hexylmethyldiethoxysilane, hexylmethyldimethoxysilane, phenylmethyldiethoxysilane, phenylmethyldimethoxysilane, diphenyldiethoxysilane, diphenyldimethoxysilane, and dimethylphenylmethoxysilane; and also alkoxysilanes that have functional organic groups such as: vinyltrimethoxysilane, vinyltriethoxysilane, vinylmethyldimethoxysilane, vinylmethyldiethoxysilane, 5-hexenyltrimethoxysilane, 3-glycidoxypropyltrimethoxysilane, 3-glycidoxypropyltriethoxysilane, 3-glycidoxypropylmethyldimethoxysilane, 3-glycidoxypropylmethyldiethoxysilane, 3-(meth)acryloxypropyltrimethoxysilane, 3-(meth)acryloxypropyltriethoxysilane, 3-(meth)acryloxypropylmethyldimethoxysilane, 3-(meth)acryloxypropylmethyldiethoxysilane, 4-vinylphenyltrimethoxysilane, 3-(4-vinylphenyl)propyltrimethoxysilane, 4-vinylphenylmethyltrimethoxysilane, 3-aminopropyltrimethoxysilane, 3-aminopropyltriethoxysilane, 3-aminopropylmethyldimethoxysilane, 3-aminopropylmethyldiethoxysilane, 3-(2-aminoethyl)aminopropyltrimethoxysilane, 3-mercaptopropyltrimethoxysilane, 3-mercaptopropyltriethoxysilane, 3-mercaptopropylmethyldimethoxysilane and 3-mercaptopropylmethyldiethoxysilane. Boron compounds, such as, for example, boron alkyl esters, preferably trimethyl borate, triethyl borate, triisopropyl borate or tributyl borate or mixtures thereof, can be used as further network former precursors. Preferably, the network former precursor is soluble in an organic solvent. Preferred organic solvents are set out later, with reference to these solvents.

Furthermore, it can be provided that the network modifier precursor comprises at least one alkali metal compound and/or alkaline earth compound, preferably a sodium and/or potassium compound, or magnesium, calcium, strontium or barium compound, particularly preferably a potassium compound.

Provision can preferably be made for the network modifier precursor to comprise at least one alkali metal compound, preferably a sodium or potassium compound, particularly preferably a potassium compound.

Preferred sodium or potassium compounds, or magnesium, calcium, strontium or barium compounds include sodium carboxylates and potassium carboxylates, or magnesium carboxylates, calcium carboxylates, strontium carboxylates and barium carboxylates. The preferred carboxylates, which particularly preferably have the formula (CH₃CₙH₂ₙCOO— with n=0-18) include decanoate, neodecanoate, 2-ethylhexanoate, cyclohexanoate, acrylates, oleates, benzoates, among others. Furthermore, dicarboxylic acids can be used to form the complexes and/or salts, which particularly preferably correspond to the formula (HOOCCₙH₂ₙCOOH with n=0-10), such as oxalic acid, malonic acid, or sebacic acid, maleic acid or fumaric acid. Furthermore, as a ligand and/or salt component, hydroxycarboxylates such as derivatives of glycolic acid, lactic acid, malic acid, mandelic acid, tartaric acid, citric acid, and/or ketocarboxylates such as salts/complexes of glyoxylic acid, pyruvic acid, acetoacetic acid or ethyl acetoacetate and/or amino carboxylates such as salts/complexes of amino acids such as glycine, alanine, valine, leucine, isoleucine, phenylalanine, tyrosine, proline, hydroxyproline, serine, threonine, cysteine, cystine, methionine, tryptophan, aspartic acid; glutamic acid, arginine, lysine, histidine can be used.

Another object of the present invention is a printing substance for carrying out a method according to the present invention, wherein the printing substance comprises at least one network former precursor and network modifier precursor and at least one pigment precursor which is soluble in an organic solvent, and the pigment precursor comprises at least one transition metal, wherein the transition metal contained in the pigment precursor is selected from cobalt, iron, chromium, copper, manganese and the network former precursor comprises at least one silicon compound, boron compound and/or bismuth compound and the network modifier precursor comprises at least one alkali metal compound.

Surprising advantages can be achieved if the molar ratio of network former compound, based on silicon, boron and/or bismuth, to the sum of the alkali metal/alkaline earth metal compound, based on the alkali metal or alkaline earth metal, is in the range from 120:1 to 1:140, preferably 12:1 to 1:14, particularly preferably in the range from 6:1 to 1:7. Preferred network former precursors, network modifier precursors and pigment precursors have been set forth above, and reference is made to such network former precursors, network modifier precursors and pigment precursors to avoid repetition. Preferably, the network former precursor is soluble in an organic solvent. Preferred organic solvents are set out later, with reference to these solvents.

Surprising advantages can be achieved in that the network former precursor comprises at least one silicon compound and the network modifier precursor comprises at least one alkali metal compound and/or alkaline earth metal compound and the molar ratio of silicon compound, based on silicon, to the sum of the alkali/alkaline earth metal compound based on the alkali metal or alkaline earth metal is in the range from 150:1 to 1:2, preferably from 12:1 to 1:1, more preferably in the range from 9:1 to 1:1.

Surprising advantages can be achieved in that the network former precursor comprises at least one silicon compound and the network modifier precursor comprises at least one alkali metal compound and/or alkaline earth metal compound and the molar ratio of silicon compound, based on silicon, to the sum of the alkali/alkaline earth metal compound based on the alkali metal or alkaline earth metal is in the range from 100:1 to 1:150, preferably from 5:1 to 1:24, more preferably in the range from 3:2 to 1:12.

Furthermore, surprising advantages can be achieved in that the network former compound comprises at least one silicon compound and boron compound. It can advantageously be provided that the molar ratio of silicon compound, based on silicon, to boron compound, based on boron, is in the range from 150:1 to 1:200, preferably 12:1 to 1:25, particularly preferably in the range of 2:1 to 1:12.

Furthermore, it can be provided that the molar ratio of pigment precursor to network former precursor is in the range from 600:1 to 1:2, preferably 30:1 to 1:1, particularly preferably in the range from 10:1 to 3:2.

Furthermore, it can be provided that the molar ratio of pigment precursor to network former precursor is in the range from 600:1 to 1:2, preferably 30:1 to 2:3, particularly preferably in the range from 15:1 to 1:1.

Furthermore, it can be provided that the molar ratio of pigment precursor to network former precursor is in the range from 600:1 to 1:2, preferably 30:1 to 1:1, particularly preferably in the range from 20:1 to 5:1.

Furthermore, it can be provided that the molar ratio of pigment precursor to network modifier precursor is in the range from 600:1 to 1:2, preferably 30:1 to 1:1, particularly preferably in the range from 22:1 to 3:2.

The network former precursor and/or network modifier precursor preferably form a glass matrix, as is known from the prior art, which is exemplified above. In this case, the glass matrix is of an inorganic nature and is particularly preferably based on SiO₂. The glass matrix acts as an adhesion promoter or adhesion enhancer between the substrate and the pigment.

In general, a printing substance according to the invention can contain binders and other customary additives. These include, inter alia, defoamers, neutralizing agents, leveling agents, wetting agents, rheological additives and/or stabilizers. Defoamers, neutralizing agents, leveling agents, wetting agents, dispersants, rheological additives and/or stabilizers are preferably used in an amount of 0 to 50% by weight, more preferably 0.1 to 30% by weight and especially preferably 1 to 20% % by weight, based on the total mass of the printing substance. Defoamers can be selected, for example, from modified acrylates or modified acrylate copolymers, but also, and this is preferred, from compounds containing silicone. Leveling agents include, for example, modified polyacrylates and polysiloxanes.

Particularly preferred additives are homogenizing agents, which are used in particular in systems containing Co and/or Cu. They can also act as ligands here, since a color change from blue to violet is sometimes observed in systems containing Co, which is an indication therefor. It can therefore be provided that the printing substance comprises a homogenizing agent, preferably an amine compound, particularly preferably ethanolamine, diethanolamine, triethanolamine and/or 2-amino-2-methyl-1-propanol. The proportion by weight of the homogenizing agent in the printing substance is preferably in the range from 0 to 40% by weight, particularly preferably in the range from 1.5 to 20% by weight.

The binders can be cellulose, cellulose derivatives, poly(meth)acrylates, polyvinyl alcoholates, polyvinyl pyrrolidones, polyvinyl acetates, polyamides, polyurethanes and derivatives of these, as well as hydrocarbon resins, maleic acid resins, styrene resins, colophony resins, phenolic resins and combinations thereof.

Particularly preferred binders are alkyl celluloses and hydroxyalkyl celluloses such as ethyl cellulose and hydroxypropyl cellulose.

Furthermore, the printing substance can contain organic solvents. As a result, the workability can be improved. Organic solvents are compounds containing carbon and hydrogen atoms that are removed from the coating after the printing substance is applied. This can be done by burning, i.e. heating the printed substrate to the temperatures set out above for converting the pigment precursor into pigment particles, which are preferably in the range from 400° C. to 1000° C., preferably 550° C. to 750° C., particularly preferably 620° C. to 700° C., especially preferably 650° C. to 690° C.

It can also be provided that the printing substance comprises a solvent, wherein the solvent is preferably selected from glycols, glycol ethers, glycol acetates, terpineol, alcohols, water, ketones, esters, diacetone alcohol, alkanolamines, aromatic hydrocarbons, aliphatic hydrocarbons and/or alkanoic acids and sulfonic acids. The pigment precursor and the network modifier precursor are particularly preferably soluble in the solvent used, wherein all of the components mentioned are particularly preferably soluble in the solvent used.

Furthermore, it can be provided that the proportion by weight of the solvent in the printing substance is in the range from 5 to 50% by weight, preferably 10 to 40% by weight, particularly preferably 7 to 40% by weight.

Furthermore, it can be provided that the printing substance has a viscosity in the range of 3 mPas-20 Pas at a shear rate of 200 s-1 and 23° C., measured according to cone/plate 2° 20.

In one configuration, the printing substance is suitable for inkjet printing methods (inkjet methods). It can therefore be provided that the printing substance, preferably the ink, has a viscosity in the range from 3 mPas to 100 mPas at a shear rate of 600 s⁻¹ and 23° C., measured with a cone/plate (2° 20) on a rotational viscometer.

In a preferred embodiment, the printing substance is suitable for screen printing methods. It can therefore be provided that the printing substance, preferably the ink, has a viscosity in the range from 1.5 Pas to 20 Pas at a shear rate of 200 s⁻¹ and 23° C., measured with a cone/plate (2° 20) on a rotational viscometer.

Another object of the present invention is a coated glass substrate obtainable by a method according to the present invention, wherein the glass coating in the fired state has a thickness in the range from 0.6 μm to 8 μm, preferably in the range from 0.8 to 4.0 μm and particularly preferably in the range from 1.0 to 3.0 μm.

Surprisingly, due to the small thickness of the glass coating, an improvement in the bending strength of the coated glass is achieved, so that this leads to only a slight reduction in the bending strength of the pure substrate.

Furthermore, it can be provided that the coating of the glass substrate comprises pigment particles, wherein the pigment particles have, inter alia, in the case of Co-containing systems, an average particle diameter in the range from 0.05 μm to 0.8 μm, preferably from 0.08 μm to 0.6 μm, particularly preferably from 0.1 to 0.5 μm wherein the average size is determined from the numerical mean of scanning electron micrographs using at least 20 pigment particles. In general, the pigments are visible as bright spots in the REM, without this being intended to be a limitation. Corresponding values apply to other pigment systems, although these should have a similar opacity.

Furthermore, it can be provided that the part of the glass substrate provided with a coating has an optical density of at least 1.0, preferably at least 2.0, particularly preferably at least 3.0, measured using a transmission densitometer, the measurement being taken at room temperature (20° C.). For example, the optical density can be measured using a Gretag D 200-11 transmission densitometer.

Glass substrates and coated glass substrates are exposed to different loads so that they are selected depending on the application. The resilience required is defined by corresponding standards or requirements of the purchaser. The present coatings are preferably made and their components selected to meet these requirements and standards.

Furthermore, it can be provided that the coated glass substrate has a high acid resistance, so that wetting with an acid or base over a period of 5 minutes leads to at most a slight, preferably insignificant, change in the coating (20° C.). The coating is particularly resistant to 10% by weight hydrochloric acid, 0.1N sulfuric acid, 10% by weight citric acid, 10% by weight acetic acid and/or 10% by weight sodium hydroxide solution.

Furthermore, it can be provided that the coated glass substrate has an average bending strength of at least 100 N/mm 2, preferably 130 N/mm 2, measured according to the ring fracture test, which is exemplified in the examples. These values relate to a plate thickness of 1.9 mm. Thicker plates have correspondingly higher values, thinner plates have correspondingly lower values. A standard automotive glass paint such as 14 510 from Ferro showed an average value of 75 N/mm 2 on 1.9 mm thick glass plates. In addition, it can be provided that the coating of the glass substrate has a scratch resistance of at least 5 N, preferably of at least 20 N, measured with a scratch hardener model 318 with rollers tip 1.0 from Erichsen.

The color of the coating applied to the glass substrate is not particularly limited and can be selected according to requirements. To protect adhesives that are used, for example, in the processing or installation of the coated glass substrate in an automobile, it is advantageous to choose dark colors that absorb as much light as possible. It can therefore preferably be provided that the coating of the glass substrate is black.

The color values are preferably measured using an X-Rite Model SP 964 colorimeter. The color measurement is based on DIN 5033 with a reflection spectrophotometer with circular illumination of 0° and an observation angle of 45°. The device measures the spectral reflectance within a range of 400-700 nm and calculates the colorimetric data. The color difference between the reference and the sample is calculated in accordance with DIN 6174.

Furthermore, it can be provided that the color values for L*≤15, a* are between −5 and +6, b* between −4 and +5, preferably for L*≤14, a* between −4 and +4, b* between −3 and +3, particularly preferably when L*≤8, a* between −4 and +4, b* between −3 and +3, particularly preferably L*≤5, a* between −1 and +1 and b*be between −1.7 and +1.5. The present invention is explained in more detail below with reference to examples, without there being any intention to limit the invention.

Test Method

Bending Strength

The bending strength is determined by the following method. The plates preferably have a size of 10 cm×10 cm×1.9 mm.

The glass plates are placed in the bending strength measuring apparatus with the colored side down on a silicon pad about 2 mm thick. This lies on a 2 mm high metal ring. The ring is slightly smaller in diameter than the plates. A metal rod then presses down on the glass side of the plate with slowly increasing force until it breaks. The bending strength S is calculated from the required force F and the thickness of the glass plate using the formula

$$S = \frac{1.04}{{h}^{2}} \times F$$

The bending strength must be determined on several plates, since individual plates could have previous damage, which would falsify the result. In fact, as a rule, a clear scattering of the values is determined. One should measure about 20 samples and form the numerical mean in order to be able to make a significant statement.

Optical Density

The optical density is measured using a Gretag D 200-II transmission densitometer.

Acid and Base Resistance

To test the chemical resistance of the glass colors, a drop of diluted acid or lye is placed on the finished color coating and this is only washed off again after 5 minutes. The solutions used are 0.1 N sulfuric acid
hydrochloric acid 10%
citric acid 10%
acetic acid 10%
caustic soda 10%

The acid and alkali resistance of the color coatings is categorized as follows:
1=no attack
2=iridescence of the surface or just noticeable loss of gloss
3=clear matting without deeper color or surface changes
4=deeper color or surface change or no longer scratch-resistant
5=coating removed, substrate is completely or partially exposed

Scratch Hardness

To determine the scratch hardness, an Erichsen hardness test rod, on which the compressive force can be set in Newtons, is scratched onto the glass plates before and after the firing process. A metal spring in the test rod is adjusted to the desired spring force with a slider. A few centimeters long scratch can then be drawn by hand with the tip of the rod on the surface to be examined. The maximum adjustable spring force of the hardness test rod is 20 Newtons.

The scratch hardness is the force starting from which the scratch is not visible from the back of the glass plate.

The printing substances set out in the following tables are produced by mixing:

### Example 1

| Raw material | Target [g] | Mass fraction |
|---|---|---|
| Cobalt solution (21% based on Co) | 34.5 | 44.15% |
| consisting of 60-70% cobalt neodecanoate, | | |
| 10-20% cobalt dihydroxide and 10-20% | | |
| organic solvent, preferably n-alkanes, iso- | | |
| alkanes and/or cyclic alkanes with 11-14 | | |
| carbon atoms, wherein the proportion of | | |
| aromatics is <2%. | | |
| 3-trimethoxysilylpropyl methacrylate | 9 | 11.52% |
| Potassium ethyl hexanoate (15% based on | 2.25 | 2.88% |
| K) in diethylene glycol | | |
| Triethanolamine (Sigma-Aldrich) | 5.4 | 6.91% |
| AT45 in butyl diglycol (Ferro GmbH) | 27 | 34.55% |

Triethanolamine improves the homogenization of the components, which is carried out in a DISPERMAT type stirrer (5 min at approx. 1500-2000 rpm). AT45 (Ferro) is a printing medium that is commonly used in the printing ink industry to set viscosity values suitable for screen printing.

To determine the bending strength, glass plates measuring 10 cm×10 cm×2 mm are machine printed with a 90 nylon screen. The oven is preheated to around 300° C. and all the printed glass plates are placed in it. The oven is then ramped up to 650° C. at maximum power and switched off after a holding time of 7 minutes. The glass plates are removed after a few hours, as soon as their temperature is below approx. 200° C. Otherwise, the glass plates are usually placed in the hot oven between 550° and 750° C., fired for 1-5 minutes and then taken out of the oven and cooled in the air.

The bending strength is 145+/−49 N/mm 2 and is therefore in the range of 140+/−42 N/mm 2 for the unprinted panels.

The coating has a high acid and base resistance. A rating of 1 (=no attack) is given for the acids and bases presented.

The scratch hardness is at least 20 N (upper measurement limit)

The optical density is: 2.05

### Example 2

| Raw material | Target [g] | Mass fraction |
|---|---|---|
| Cobalt solution (21% based on Co) | 8.33 | 43.21% |
| consisting of 60-70% cobalt neodecanoate, | | |
| 10-20% cobalt dihydroxide and 10-20% | | |
| organic solvent, preferably n-alkanes, iso- | | |
| alkanes and/or cyclic alkanes with 11-14 | | |
| carbon atoms, where the proportion of | | |
| aromatics is <2%. | | |
| 3-trimethoxysilylpropyl methacrylate | 2.25 | 11.67% |
| Potassium ethyl hexanoate (15% based on | 0.56 | 2.90% |
| K) in diethylene glycol | | |
| Triethanolamine (Sigma-Aldrich) | 1.36 | 7.05% |
| AT10 (Ferro GmbH) | 6.78 | 35.17% |

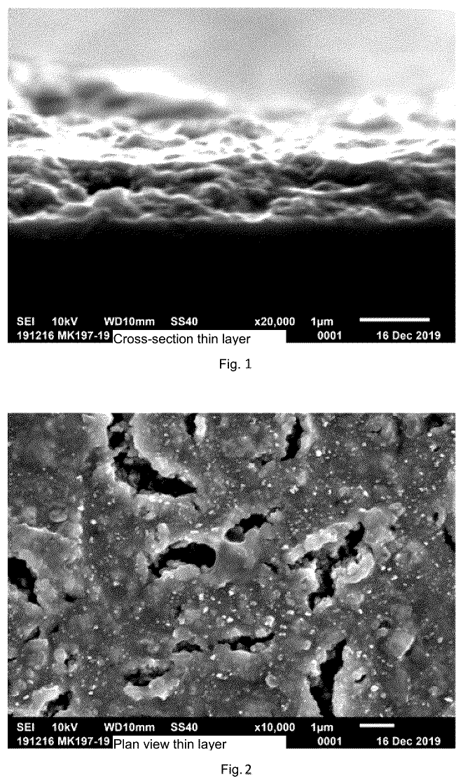

The coating is printed with a 90T screen and then dried at 120° C. for 20 minutes. The subsequent firing takes place at a temperature of 675° C. for 3 minutes, wherein a coating thickness of 1-2 μm is obtained. FIG. 1 shows a cross-section of an electron micrograph, from which the thickness can be seen. The coating is examined by electron microscopy, wherein the formation of pigment particles can be seen. This image is shown in FIG. 2. The optical density is: 2.39.

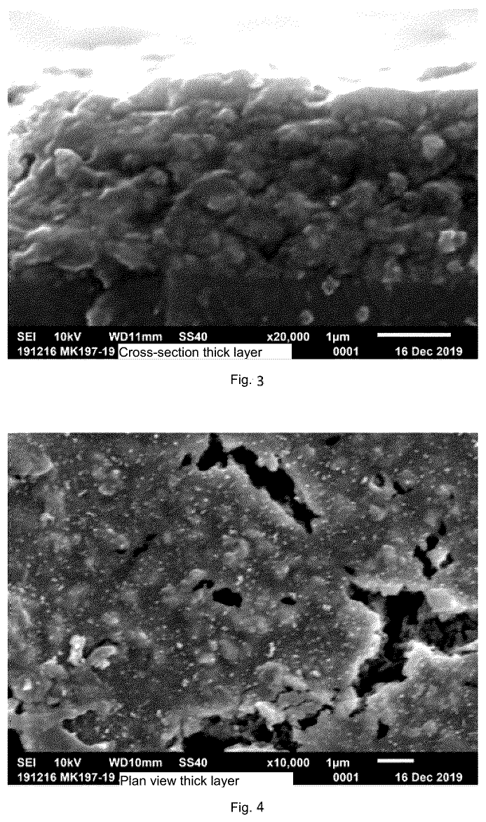

If the fired layer is printed again with a 90T screen, dried again for 20 minutes at 120° C. and then the glass plate is fired again for 3 minutes at 675° C., the result is a layer thickness of 2.5-3 μm as visible in an electron micrograph, FIG. 3. The further formation of pigment particles can also be observed in FIG. 4 by means of electron microscopy. The optical density is: 4.36.

### Example 3

| Raw material | Target [g] | Mass fraction |
|---|---|---|
| Cobalt solution (21% based on Co) | 16.02 | 58.90% |
| consisting of 60-70% cobalt neodecanoate, | | |
| 10-20% cobalt dihydroxide and 10-20% | | |
| organic solvent, preferably n-alkanes, iso- | | |
| alkanes and/or cyclic alkanes with 11-14 | | |
| carbon atoms, where the proportion of | | |
| aromatics is <2%. | | |
| 3-trimethoxysilylpropyl methacrylate | 2.05 | 7.54% |
| Potassium ethyl hexanoate (15% based on | 0.81 | 2.98% |
| K) in diethylene glycol | | |
| Triethanolamine (Sigma-Aldrich) | 1.31 | 4.82% |
| dispersing additive | 1.01 | 3.71% |
| AT10 (20% in BDG) (Ferro GmbH) | 6.00 | 22.06% |

The coating is printed with a 61T screen and then dried at 130° C. for 15 minutes. The subsequent firing takes place at a temperature of 670° C. for 3 minutes.

The coating has a high acid and base resistance. A rating of 1 (=no attack) is given for the acids and bases presented.

The optical density is 3.61.

The L* value was 13.26, the a* value −3.30 and the b* value+2.05.

The scratch hardness is 10 N.

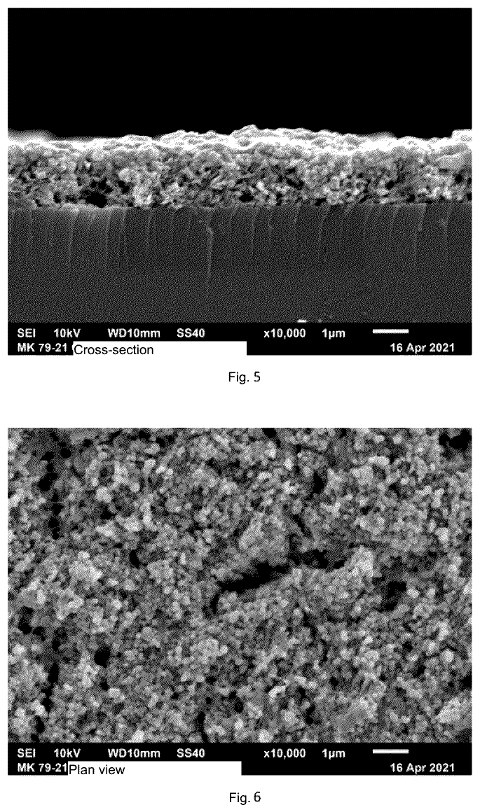

FIG. 5 shows a cross-section of an electron micrograph, from which the thickness can be seen. The coating is examined by electron microscopy, where the formation of pigment particles can be seen. This image is shown in FIG. 6.

### Example 4

| Raw material | Target [g] | Mass fraction |
|---|---|---|
| Manganese decanoate (8% based on Mn) | 5.31 | 35.21% |
| Copper decanoate (8% based on Cu) | 7.1 | 47.08% |
| 3-trimethoxysilylpropyl methacrylate | 1.73 | 11.47% |
| Potassium ethyl hexanoate (15% based on | 0.21 | 1.39% |
| K) in diethylene glycol | | |
| Triethanolamine (Sigma-Aldrich) | 0.3 | 1.99% |
| Ethocel Standard 10 in butyldiglycol 20% | 0.43 | 2.85% |

The preparation is applied with a 12 μm spiral squeegee and then fired at 675° C. for 3 minutes. The optical density is: 1.1.

Chemical resistance shows a rating of 1 (no attack).

The L* value was 4.56, the a* value−0.41 and the b* value−1.60.

The scratch hardness is 10 N.

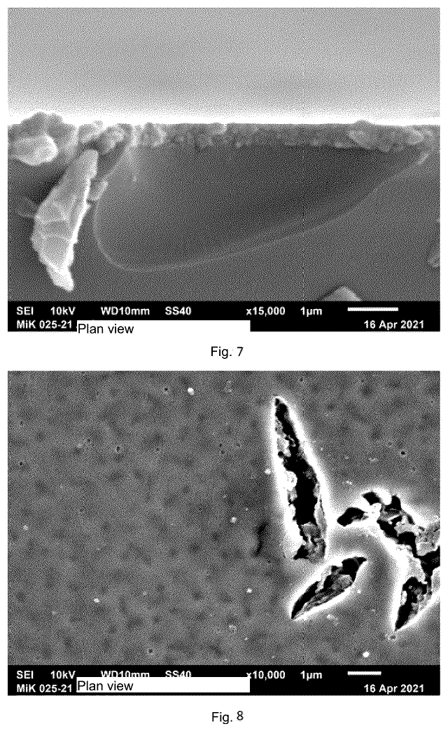

FIG. 7 shows a cross-section of an electron micrograph, from which the thickness can be seen. FIG. 8 shows the surface of the coating.

### Example 5

| Raw material | Target [g] | Mass fraction |
|---|---|---|
| Manganese decanoate (8% based on Mn) | 7.148 | 43.34% |
| Copper decanoate (8% based on Cu) | 6.485 | 39.32% |
| Iron ethyl hexanoate (7-8% based on Fe) | 1.36 | 8.25% |
| Ethocel Standard 10 in butyldiglycol 20% | 1.5 | 9.09% |

The preparation is applied with a 12 μm spiral squeegee and then fired at 675° C. for 3 minutes. The optical density is: 1.3.

### Example 6

| Raw material | Target [g] | Mass fraction |
|---|---|---|
| Manganese decanoate (8% based on Mn) | 17.35 | 40.33% |
| Copper carbonate in ethanolamine (12% | 14.58 | 33.89% |
| based on Cu) | | |
| 3-trimethoxysilylpropyl methacrylate | 9.87 | 22.94% |
| Ethocel Standard 10 in butyldiglycol 20% | 1.22 | 2.84% |

The coating is printed with a 61T screen and then dried at 130° C. for 15 minutes. The subsequent firing takes place at a temperature of 670° C. for 3 minutes.

The optical density is: 1.2.

The L* value was 4.83, the a* value was +5.19 and the b* value was +4.32.

The scratch hardness is 10 N.

### Comparative Example 1

Printed all over, a commercial Ferro product GSGA Black 14510 IR-9864-C reduces the bending strength to just S=75+/−17 N/mm². The coating is obtained with the same printing and firing method as carried out in Example 1.

### Example 7

| Raw material | Target [g] | Mass fraction |
|---|---|---|
| Cobalt solution (21% based on Co) | 6.13 | 30.66% |
| consisting of 60-70% cobalt neodecanoate, | | |
| 10-20% cobalt dihydroxide and 10-20% | | |
| organic solvent, preferably n-alkanes, iso- | | |
| alkanes and/or cyclic alkanes with 11-14 | | |
| carbon atoms, where the proportion of | | |
| aromatics is <2%. | | |
| Potassium ethyl hexanoate (15% based on | 3.81 | 19.05% |
| K) in diethylene glycol | | |
| Copper decanoate (8% based on Cu) | 1.28 | 6.40% |
| 3-trimethoxysilylpropyl methacrylate | 0.40 | 2.00% |
| boric acid tributyl ester | 3.00 | 15.00% |
| dispersing additive | 0.688 | 3.44% |
| Triethanolamine (Sigma-Aldrich) | 0.922 | 4.61% |
| Ethocel Standard 10 in butyldiglycol 20% | 3.766 | 18.83% |

The coating is printed with a 77T screen and then dried at 130° C. for 15 minutes. The subsequent firing takes place at a temperature of 670° C. for 3 minutes.

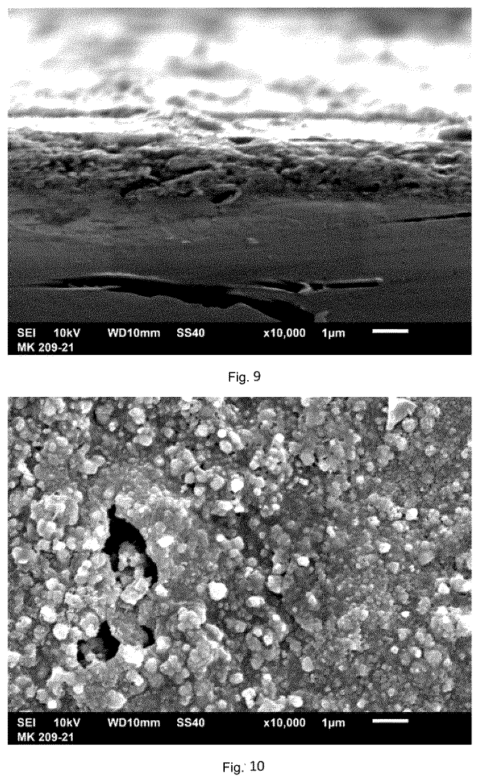

FIG. 9 shows a cross-section of an electron micrograph, from which the thickness of approx. 1.7 μm can be seen. The coating is examined by electron microscopy, wherein the formation of pigment particles can be seen. This image is shown in FIG. 10.

The optical density is: 2.91.

The L* value was 6.59, the a* value was −1.57 and the b* value was +1.39.

The scratch hardness is >20 N

### Example 8

| Raw material | Target [g] | Mass fraction |
|---|---|---|
| Cobalt solution (21% based on Co) | 9.13 | 45.66% |
| consisting of 60-70% cobalt neodecanoate, | | |
| 10-20% cobalt dihydroxide and 10-20% | | |
| organic solvent, preferably n-alkanes, iso- | | |
| alkanes and/or cyclic alkanes with 11-14 | | |
| carbon atoms, where the proportion of | | |
| aromatics is <2%. | | |
| Potassium ethyl hexanoate (15% based on | 1.81 | 9.05% |
| K) in diethylene glycol | | |
| Copper decanoate (8% based on Cu) | 1.60 | 8.00% |
| 3-trimethoxysilylpropyl methacrylate | 0.80 | 4.00% |
| boric acid tributyl ester | 1.28 | 6.40% |
| dispersing additive | 0.688 | 3.44% |
| Triethanolamine (Sigma-Aldrich) | 0.922 | 4.61% |
| Ethocel Standard 10 in butyldiglycol 20% | 3.766 | 18.83% |

The coating is printed with a 77T screen and then dried at 130° C. for 15 minutes. The subsequent firing takes place at a temperature of 670° C. for 3 minutes.

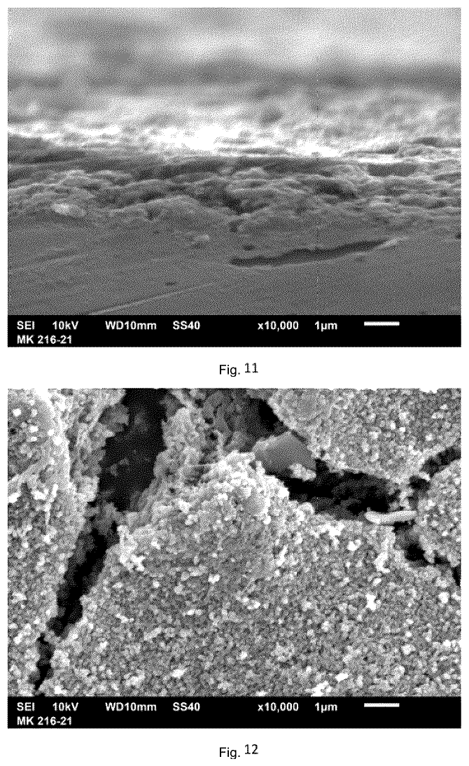

FIG. 11 shows a cross-section of an electron micrograph, from which the thickness of approx. 2.3 μm can be seen. The coating is examined by electron microscopy, wherein the formation of pigment particles can be observed. This image is shown in FIG. 12.

The optical density is: 4.37.

The L* value was 7.72, the a* value was +1.20 and the b* value was +2.63.

The scratch hardness is >20 N

### Example 9

| Raw material | Target [g] | Mass fraction |
|---|---|---|
| Cobalt solution (21% based on Co) | 7.44 | 37.23% |
| consisting of 60-70% cobalt neodecanoate, | | |
| 10-20% cobalt dihydroxide and 10-20% | | |
| organic solvent, preferably n-alkanes, iso- | | |
| alkanes and/or cyclic alkanes with 11-14 | | |
| carbon atoms, where the proportion of | | |
| aromatics is <2%. | | |
| Potassium ethyl hexanoate (15% based on | 3.81 | 19.06% |
| K) in diethylene glycol | | |
| Copper decanoate (8% based on Cu) | 1.28 | 6.40% |
| 3-trimethoxysilylpropyl methacrylate | 0.80 | 4.00% |
| boric acid tributyl ester | 1.28 | 6.40% |
| dispersing additive | 0.688 | 3.44% |
| Triethanolamine (Sigma-Aldrich) | 0.922 | 4.61% |
| Ethocel Standard 10 in butyldiglycol 20% | 3.766 | 18.83% |

The coating is printed with a 77T screen and then dried at 130° C. for 15 minutes. The subsequent firing takes place at a temperature of 670° C. for 3 minutes.

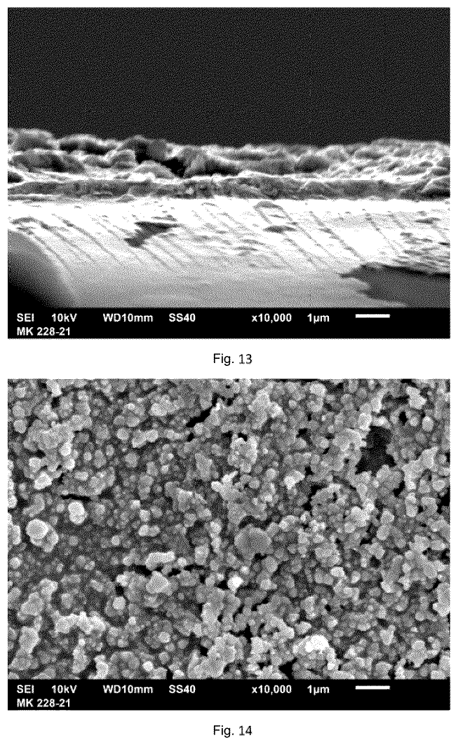

FIG. 13 shows a cross-section of an electron micrograph, from which the thickness of approx. 1.5 μm can be seen. The coating is examined by electron microscopy, where the formation of pigment particles can be observed. This image is shown in FIG. 14. The optical density is: 3.11.

The L* value was 4.25, the a* value −1.04 and the b* value+1.18.

The scratch hardness is >20 N.

The examples show that the present invention achieves the objects set out above, in which in particular the bending strength of a decoration obtained using the printing substance according to the invention can be surprisingly significantly increased without other properties of the printing substance or of the decoration being adversely affected as a result.

1-25. (canceled)

26. A coated glass substrate, wherein a coating comprises an inorganic glass matrix and pigment particles, wherein the coating has a thickness in the range from 0.6 μm to 8 μm in the fired state and the color values of the coating are in the range for L*≤15, for a* lie between −5 and +6, and for b* lie between −4 and +5.

27. The coated glass substrate according to claim 26, wherein the part of the glass substrate provided with a coating has an optical density of at least 1.0.

28. The coated glass substrate according to claim 26, wherein the pigment particles have an average particle diameter in the range from 0.05 μm to 0.8 μm, wherein the average size is determined from the numerical mean value of scanning electron micrographs using at least 20 pigment particles.

29. The coated glass substrate according to claim 26, wherein the coating of the glass substrate has a scratch resistance of at least 5 N, measured with a scratch hardening pin model 318 with rollers with 1.0 tip from Erichsen.

30. The coated glass substrate according to claim 26, wherein the glass substrate is selected from the group consisting of a windscreen, a side window, a rear window and/or a roof window of a motor vehicle.

31. The coated glass substrate according to claim 26, wherein the coating has a thickness in the range from 1.0 to 3.0 μm in the fired state.

32. The coated glass substrate according to claim 26, wherein the color values of the coating applied to the glass substrate are, in the range for L* 5, for a* in the range between −1 and +1 and for b* between −1.7 and +1.5.

33. The coated glass substrate according to claim 26, wherein the coating applied to the glass substrate covers the edge of the glass substrate, wherein the edge covered by the coating has a width in the range from 0.5 cm to 20 cm, and the glass substrate has an inner uncoated region surrounded by the edge.

34. The coated glass substrate according to claim 26, wherein at least one network forming precursor and/or at least one network modifying precursor form a glass matrix.

35. A method for producing a coated glass substrate according to claim 26 with a printing method, wherein
A) a printing substance is applied to a glass surface, wherein the printing substance comprises at least one pigment precursor; and
B) the pigment precursor applied to the glass surface is converted to pigment particles by a heating step.

36. The method according to claim 35, wherein the heating step comprises firing the coated glass surface to a temperature in the range from 400° C. to 1000° C.

37. The method according to claim 35, wherein the heating step is carried out over a period of 1 minute to 180 minutes.

38. The method according to claim 35, wherein the printing substance comprises at least one network forming precursor and/or network modifying precursor and at least one pigment precursor which is soluble in an organic solvent, and the pigment precursor comprises at least one transition metal.

39. The method according to claim 35, wherein the transition metal contained in the pigment precursor is selected from the group consisting of cobalt, iron, nickel, manganese, chromium, copper, aluminum, titanium, and molybdenum.

40. The method according to claim 35, wherein the transition metal contained in the pigment precursor is selected from the group consisting of iron, nickel, manganese, chromium, copper, aluminum, titanium, molybdenum, ruthenium, preferably iron, chromium, copper, manganese, particularly preferably manganese, iron and copper or copper, chromium, iron or copper, manganese, iron or copper and manganese.

41. The method according to claim 35, wherein the network forming precursor comprises at least one of a silicon compound, a boron compound and a bismuth compound.

42. The method according to claim 35, wherein the network modifying precursor comprises at least one alkali metal compound.

43. A printing substance for carrying out the method according to claim 35, wherein the printing substance comprises at least one network forming precursor, and at least one network modifying precursor, and at least one pigment precursor which is soluble in an organic solvent, wherein the pigment precursor comprises at least one transition metal selected from the group consisting of cobalt, iron, chromium, copper, and manganese, wherein the network forming precursor comprises at least one of a silicon compound, a boron compound and a bismuth compound and wherein the network modifying precursor comprises at least one alkali metal compound.

44. The printing substance according to claim 43, wherein the molar ratio of network forming compound, based on silicon, boron and/or bismuth, to the sum of the alkali metal/alkaline earth metal compound, based on the alkali metal or alkaline earth metal, is in the range from 120:1 to 1:140.

45. A coated glass substrate obtainable by the method according to claim 35, wherein the glass coating in the fired state has a thickness in the range from 0.6 μm to 8 μm.
